(19) United States
(12) Patent Application Publication
(10) Pub. No.: US 2011/0281363 A1
(43) Pub. Date: Nov. 17, 2011

(54) SENSITIVE AND SELECTIVE DETECTION METHOD FOR MERCURY (II) IN AQUEOUS SOLUTION

(76) Inventors: Alice E. Bruce, Orono, ME (US); Carl P. Tripp, Orono, ME (US); Mitchell R.M. Bruce, Orono, ME (US); Amer A.G. Al Abdel Hamid, Irbid (JO); Asela C. Maha Acharige, Old Town, ME (US)

(21) Appl. No.: 13/088,353

(22) Filed: Apr. 16, 2011

Related U.S. Application Data
(60) Provisional application No. 61/324,884, filed on Apr. 16, 2010.

(51) Int. Cl. G01N 21/35; G01N 21/00; G01N 21/75

(52) U.S. Cl. 436/80; 436/73; 436/81; 422/82.05

(57) ABSTRACT

A method for detecting and measuring a metal ion in an aqueous medium includes derivatizing a solid phase extraction material with a reactive material that undergoes a chemical reaction when contacted with the metal ion. The solid phase extraction material and the reactive material are positioned in an aqueous medium containing the metal ion, such that the metal ion contacts the reactive material and causes it to chemically react. The reaction of the reactive material is detected by optical spectroscopy to detect and measure the metal ion.

### CROSS-REFERENCE TO RELATED APPLICATIONS

This application claims the benefit of U.S. Provisional. Application No. 61/324,884, filed Apr. 16, 2010, the disclosure of which is incorporated herein by reference.

### BACKGROUND OF THE INVENTION

This invention relates in general to analytical methods and instruments for detecting and measuring trace metal ions in an aqueous medium.

The health risks associated with mercury accumulation in the environment are well known and this has provided the motivation for developing methods for detection of low levels of mercury. The most common techniques used today for mercury detection include cold-vapor atomic absorption spectroscopy (CVAAS), inductively coupled plasma-atomic emission spectrometry, gas chromatography-inductively coupled plasma-mass spectrometry (GC-ICPMS), and cold-vapor atomic fluorescence spectrometry (CVAFS). While these techniques provide detection limits ranging between low parts per billion to low parts per trillion levels, they require stringent sample preparation protocols and specialized and costly lab-based instrumentation. Development of new detection methods that lead to field deployable detection systems or simplify sample preparation will improve our ability to monitor mercury in the environment.

These same goals were the motivation behind our recent development of a new and simple method for Fe(III) detection in seawater, which is described in International Publication No. WO/2009/105422 published Aug. 27, 2009 (incorporated by reference herein). In this case, the detection system used a combination of solid phase extraction (SPE) with infrared spectroscopy. A siderophore was tethered to a high surface area silica and the chelation of Fe(III) with the siderophore led to a detectable change in the infrared spectrum. The infrared spectrum was recorded directly on the SPE material and thus no elution of the target compound was required. Using this approach, detection of Fe(III) at the low parts per trillion in seawater were obtained in field tests conducted in the Gulf of Alaska.

There is still a need for a method for detection of metal ions other than Fe(III) that can achieve high sensitivity and selectivity.

### SUMMARY OF THE INVENTION

A method for detecting and measuring a metal ion in an aqueous medium comprises derivatizing a solid phase extraction material with a reactive material that undergoes a chemical reaction when contacted with the metal ion. The solid phase extraction material and the reactive material are positioned in an aqueous medium containing the metal ion, such that the metal ion contacts the reactive material and causes it to chemically react. The reaction of the reactive material is detected by optical spectroscopy to detect and measure the metal ion.

A detection system for detecting and measuring a metal ion in an aqueous medium comprises a solid phase extraction material derivatized with a reactive material that undergoes a chemical reaction when contacted with the metal ion. The system also includes an optical spectrometer adapted to detect the changing of the optical spectrum of the reactive material caused by the chemical reaction thereby allowing the spectrometer to detect and measure the metal ion.

Various aspects of the method and detection system will become apparent to those skilled in the art from the following detailed description of the preferred embodiments, when read in light of the accompanying drawings.

### BRIEF DESCRIPTION OF THE DRAWINGS

As described in more detail in the Experimental section hereinbelow, FIG. 1 shows IR spectra of (a) a silica film reacted with TESA, (b) followed by exposure of the sample to air overnight, then (c) reaction with DTSC to form DTSC-[silica]. FIG. 1 inset shows the spectral region of surface hydroxyl groups (SiOH) for coated Si wafer (d) before and (e) after reaction with TESA.

FIG. 2 shows the IR spectra of (a) DTSC-[silica] and (b) after the reaction with Hg(OOCCH₃)₂.

FIG. 3 shows the IR spectra of (a) DTSC-[silica], after reaction of DTSC-[silica] with (b) Hg(OOCCH₃)₂, and (c) HgCl₂.

FIG. 4 shows the IR spectra of (a) DTSC-[silica] and after exposure to (b) 50 μM CdCl₂, (c) 50 μM Pb(NO₃)₂, (d) 50 μM ZnSO₄, (e) 50 μM FeCl₃ and (f) 50 μM Hg(OOCCH₃)₂.

FIG. 5 shows the integrated peak area for the 1638 cm⁻¹ band as a function of contact time for DTSC-[silica] with 20 ml of (a) 50 μM and (b) 25 μM of Hg(OOCCH₃)₂.

FIG. 6 shows a plot of IR integrated intensity of the band at 1638 cm⁻¹ as a function of mass of Hg(II).

### DETAILED DESCRIPTION OF THE PREFERRED EMBODIMENT

The invention relates to a detection method and a detection system for detecting and measuring a metal ion in an aqueous medium. The detection system comprises a substrate that provides mechanical stability and is sized and shaped to intercept an optical beam (for example, a beam in the ultraviolet, visible or infrared region). A reactive material is attached to the substrate, for example attached to the surface of the substrate or to a film that coats the substrate. The reactive material is capable of reacting with the metal ion and changing its optical spectrum upon reacting.

The detection system and method are specifically directed at metal ions that cause or promote a chemical reaction on the material. The metal ion may, but does not have to be incorporated into the chemical structure leading to a change in the optical signature. In one embodiment the metal ion forms a byproduct and the reaction proceeds stoichiometrically. In another embodiment, the metal ion is a catalyst for the reaction and this leads to amplification of the optical spectrum and lower detection limits. Examples of metal ions that meet this criteria are, but not limited to, Hg(II), Au(I), Au(III), Zn(II), Ag(I). A particular example of this is shown below in Scheme 2.

The detection system also comprises an optical spectrometer producing the optical beam that passes through the reactive material to a detector of the spectrometer. For example, the spectrometer may be a Fourier transform, dispersive or filter based spectrometer. The changing of the optical spectrum of the reactive material allows the spectrometer to detect and measure the metal ion.

In a particular embodiment, the substrate of the detection system is transportable and disposable. For example, the substrate can be a silicon chip. In another embodiment, the substrate is a porous membrane.

The reactive material attached to a substrate, in combination with spectroscopic analysis, allows the detection system to detect and measure a metal ion in an aqueous medium. In one embodiment, the reactive material contains molecules or moieties that metal ions cause or promote a chemical reaction in the material. Examples of these molecules or moieties include, but are not limited to, chalcogen-containing organic molecules or moieties such as thiosemicarbazides, acylthiosemicarbazides; and alkynes, alkenes, allenic ketones, thioallenes, hydroxyallens, and allenic esters. Examples of metal ion catalyzed reactions are described by Hashmi (Chem. Rev 2007, 107, 3180-3211). The aqueous medium may be seawater, freshwater, or any other medium that contains predominantly water.

In a certain example, the detection system utilizes the transformation of acylthiosemicarbazide to oxadiazole rings with the SPE/infrared spectroscopic procedures developed for Fe(III) detection. In particular, a SPE material is derivatized with a thiosemicarbazide which undergoes a stoichiometric reaction when contacted with Hg(II) ions and detection is performed by infrared spectroscopic analysis directly on the material.

The reaction sequence presented in Scheme 1 depicts the preparation steps for obtaining a tethered thiosemicarbazide. A mesoporous silica film coated on a Si wafer is first derivatized with 3-(triethoxysilyl)propylsuccinic anhydride (TESA) to produce dangling COOH groups. Next, the reaction of these COOH groups with the amine functionality of a compound (for example, 4,4-dimethyl-3-thiosemicarbazide (DTSC) in Scheme 1) forms an amide linkage to the surface. Formation of the amide bond generates a thiosemicarbazide anchored to the surface.

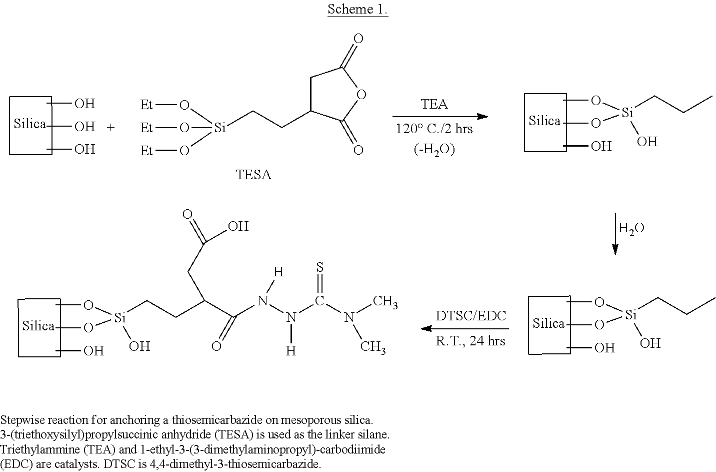

Subsequent exposure of the anchored thiosemicarbazide to Hg(II) leads to the formation of an oxadiazole and a change in the IR spectrum (see Scheme 2 below). This approach has two distinct departures from conventional SPE in that Hg(II) is not collected on the adsorbate material and elution is not required as detection is performed by infrared spectroscopic analysis directly on the adsorbate.

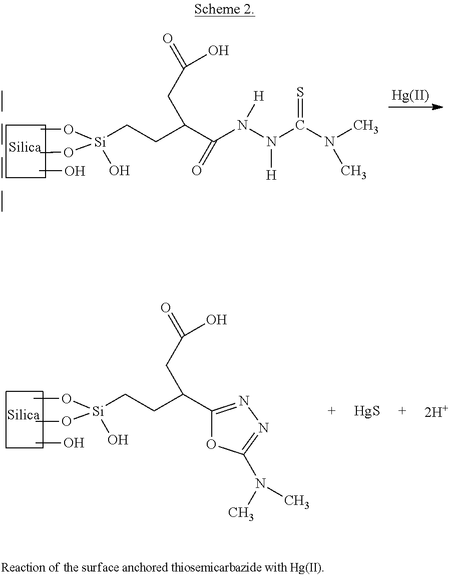

The substrate provides mechanical stability to the combination of the substrate and the reactive material and it may also provide ease of handling of the combination. Any suitable material(s) can be used to make the substrate. A water insoluble substrate may be used. The material used may depend on which optical region and which spectroscopic mode are used in the detection system. For transmission spectroscopy, the material used to make the substrate is at least partially transparent in the spectral region of interest. For example, materials such as polymers, metal oxides and metal salts, as well as common infrared window materials such as silicon may be used for transmission infrared spectroscopy. For ultraviolet or visible transmission spectroscopy, materials such as quartz, glass or transparent polymers may be used. Infrared spectroscopy in photoacoustic and reflection modes may use the above-mentioned materials or opaque and/or reflective materials such as metals for the substrate. ATR infrared spectroscopy or fiber optic ultraviolet/visible spectroscopy may be performed using an internal reflection element called a crystal or a fiber optic as the substrate, which can be made from any suitable material such as Si, Ge, ZnSe, ZnS, diamond, sapphire, CaF₂ or BaF₂ for infrared spectroscopy, and glass, quartz or transparent polymers for ultraviolet or visible spectroscopy.

The substrate is sized and shaped to intercept an optical beam from the spectrometer. The size and shape of the substrate may vary considerably depending on the spectroscopy mode used in the detection system. In one embodiment the substrate is disposable. A disposable substrate may be suitable for use in most spectroscopic modes other than ATR infrared spectroscopy. For example, a disposable substrate for use in an infrared, ultraviolet or visible transmission mode may be a rounded, square or rectangular shaped chip or wafer having an area within a range of from about 0.1 mm² to about 10 cm² and a thickness within a range of from about 25 μm to about 5 cm. The substrate may be sized and shaped for mounting in a standard or custom fabricated transmission holder of the spectrometer.

Alternatively, a crystal used as the substrate for ATR infrared spectroscopy may have an elongated rectangular or trapezoidal shape with beveled ends. The crystal can have any suitable size, for example, a length within a range of from about 0.5 cm to about 10 cm, a width within a range of from about 0.1 cm to about 3 cm, and a thickness within a range of from about 0.1 cm to about 1 cm. A fiber optic for ultraviolet or visible spectroscopy can have a length of many meters and a thickness within a range of 0.1 mm to about 1 cm.

In some embodiments the reactive material is attached directly to the substrate. In other embodiments, a material to facilitate the attachment or provide another benefit is applied to the substrate, and the reactive material is attached to that material. For example, the substrate may be coated with a layer of material such as a film to facilitate attachment of the reactive material to the substrate. The improved attachment can be by any suitable mechanism, such as adhesive and/or chemical attachment. Any suitable material can be used to facilitate the attachment.

In one embodiment, the material to which the reactive material is attached is a high surface area material such as a mesoporous silica film or porous polymer layer to increase the surface area of the substrate, so that a higher number of reactive material molecules are exposed to the metal ions in the aqueous medium. This can also be achieved by using a substrate that is porous so that the aqueous medium can pass through it.

A linker molecule can be used to modify the substrate or film surface, providing functional groups that can be used to attach a reactive material to the surface, such as carboxylic acid groups or aldehydes that can react with an amine. Some examples of chemicals that can act as a linker molecule include 3-(triethoxy-silyl) propylsuccinic anhydride, (3-aminopropyl)dimethylethoxylsilane, and triethyoxysilylbutyraldehyde. Alternatively, the reactive material can be directly attached to the substrate or film without the additional use of a linker.

The reactive material used in the detection system can be any material(s) capable of reacting with the metal ion and changing its optical spectrum upon reacting. The reactive material can have a high selectivity for a particular metal ion or it can have a general selectivity for metal ions. The reactive material can react with the metal ion in any suitable manner. In one embodiment, the reactive material is a chelator that bonds to the metal ion to form a chelate complex. Any suitable chelator can be used. For example, a class of molecules called siderophores have a high selectivity for iron. Scheme 1 above shows a siderophore called desferrioxamine B (DFB) attached to the surface of a substrate before (A) and after (B) complexation with an iron ion. Another example of a chelator is 8-hydroxyquinoline which has a general selectivity for metal ions.

The reaction of the reactive material with the metal ion alters the reactive material. In one embodiment the reactive material on the substrate can be regenerated in any suitable manner, for example by washing the substrate with a rinse solution, allowing the reactive material/substrate to be reused many times. In another embodiment, the alteration of the reactive material is irreversible, for example by the chelator complexing the metal ion irreversibly, and the reactive material/substrate in only used a single time.

The reactive material, and optionally the material which facilitates the attachment of the reactive material, can be applied to the substrate by any suitable method. For example, they can be coated on the surface of the substrate by any physical and/or chemical coating method. An example of a dry coating method includes mixing with a binder and pressing onto the substrate. Examples of wet coating methods include casting, spraying or spin coating. They may also be applied to the substrate using chemical/physical deposition or vacuum sublimation techniques. The coating can have any suitable thickness, which can vary widely depending on a particular application. In one embodiment, the coating is a relatively thin film having a thickness within a range of from about 0.1 nanometer to about 500 microns, and more particularly from about 0.2 micron to about 10 microns.

The detection system also includes an optical spectrometer producing an optical beam that passes through the reactive material to a detector of the spectrometer. The changing of the optical spectrum of the reactive material allows the spectrometer to detect and measure the metal ion.

Any optical spectroscopy technique can be used as part of the detection system, such as any of those known in the art. In brief, infrared spectroscopy is the absorption measurement of different IR frequencies by a sample positioned in the path of an IR beam. The main goal of IR spectroscopic analysis is to determine the chemical functional groups in the sample. Different functional groups absorb characteristic frequencies of IR radiation. IR spectra are obtained by detecting changes in transmittance (or absorption) intensity as a function of frequency.

UV/Vis spectroscopy is the absorption measurement of different ultraviolet and visible frequencies by a sample positioned in the path of an ultraviolet and visible beam. UV/Vis spectroscopy measures the light change by a sample due to an electronic transition in the material. The UV/VIS spectrometers are compact, low power and are currently used on moorings and gliders. Reactions caused or promoted by metal ions meta onto the reactive material can lead to unique absorption maxima in the visible. Most commercial infrared and UV/Vis instruments separate and measure the radiation using dispersive spectrometers or Fourier transform spectrometers. In a typical dispersive IR or UV/Vis spectrometer, radiation from a broad-band source passes through the sample and is dispersed by a monochromator into component frequencies. Then the beams fall on the detector, which generates an electrical signal and results in a recorder response. Fourier transform spectrometers have recently replaced dispersive instruments for most applications due to their superior speed and sensitivity. Instead of viewing each component frequency sequentially, as in a dispersive IR spectrometer, all frequencies are examined simultaneously in Fourier transform infrared (FTIR) spectroscopy. The three basic spectrometer components in an FT system are a radiation source, an interferometer and a detector.

Specular reflectance is a mode of IR or UV/Vis spectroscopy that involves a mirrorlike reflection and produces a reflection-absorption spectrum for a surface film of the sample on a reflective surface. Diffuse reflectance is another mode of IR or UV/Vis spectroscopy in which IR radiation is focused onto the surface of a sample and results in two types of reflections: specular reflectance, which directly reflects off the surface and has equal angles of incidence and reflectance, and diffuse reflectance, which penetrates into the sample, then scatters in all directions. Reflection accessories are designed to collect and refocus the resulting diffusely scattered light while minimizing the specular reflectance which distorts the IR or UV/Vis spectra. This technique is often called diffuse reflectance infrared Fourier transform spectroscopy (DRIFT).

In photoacoustic spectroscopy (PAS) the modulated IR radiation from an FTIR interferometer is focused on a sample placed inside a chamber containing an IR-transparent gas. IR radiation absorbed by the sample converts into heat inside the sample. The heat diffuses to the sample surface, then into the surrounding gas atmosphere, and causes expansion of a boundary layer of gas next to the sample surface. Thus, the modulated IR radiation produces intermittent thermal expansion of the boundary layer and generates pressure waves which are detected by a microphone.

Emission spectroscopy is another technique in which the sample is heated to an elevated temperature, emitting enough energy in the infrared region to be detected by an FTIR detector. Emission spectral bands occur at the same frequencies as absorption bands.

Attenuated total reflectance (ATR) is another mode of IR spectroscopy in which the sample is placed on the surface of a dense, high refractive index crystal. The IR beam is directed onto the beveled edge of the ATR crystal and internally reflected through the crystal with a single or multiple reflections. The beam penetrates a very short distance into the sample on the surface before the complete reflection occurs. This penetration is called the evanescent wave and typically is at a depth of a few micrometers. Its intensity is reduced (attenuated) by the sample in regions of the IR spectrum where the sample absorbs.

### EXPERIMENTAL

The TESA was purchased from Gelest Inc. and all other chemicals were obtained from Sigma-Aldrich. All chemicals were used as received unless otherwise indicated. IR-spectra were collected on a Bomem FTLA FTIR spectrometer equipped with a DTGS detector. Typically, for each spectrum, 100 scans were co-added at 4 cm⁻¹ resolution.

Selection of the Thiosemicarbazide: Initial screening of candidate thiosemicarbazides was accomplished by monitoring the solution reaction of each thiosemicarbazides with Hg(II) solutions as a function of temperature. Three readily available precursor compounds 3-aminorhodanine (ARH), 1-benzoyl-3-thiosemicarbazide (BTSC), and 4,4-dimethyl-3-thiosemicarbazide (DTSC) were tested (see Scheme 3).

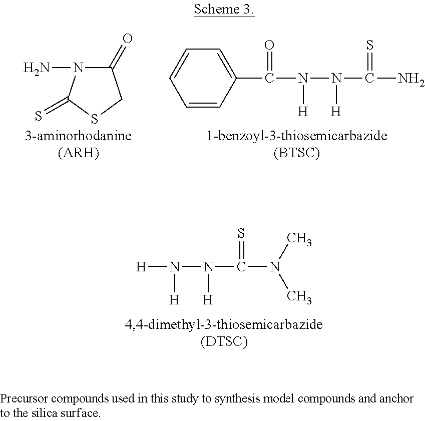

For two of the compounds, (ARH and DTSC), a thiosemicarbazide would be formed when reacted with the silane treated silica. To mimic the reaction that would occur on a surface, ARH and DTSC were converted to the corresponding thiosemicarbazides according to the reactions depicted in Scheme 4.

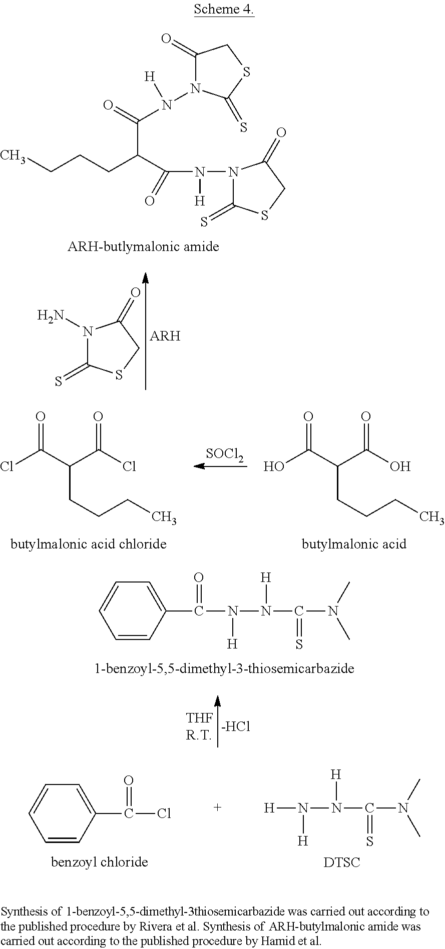

The procedure to evaluate the three model thiosemicarbazides was as follows. Solutions of 0.005M of each model thiosemicarbazides were prepared by dissolving known amounts in 50% v/v ethanol/distilled water solution. A second solution of 0.005M Hg(OOCCH₃)₂ was prepared by dissolving a measured amount of Hg(OOCCH₃)₂ in 5% acetic acid solutions (pH 2.0-2.5) and 20 ml portions of this Hg(II) solution was added to 20 ml of 0.005M of each model thiosemicarbazide solution. Reactions of model thiosemicarbazides with Hg(II) were carried out at temperatures ranging from room temperature to 100° C. The progress of the reaction was visually monitored by the formation of a black precipitate (HgS).

Preparation of Si Chips: A mesoporous silica film was prepared using an established procedure.³⁴ A solution containing 13.5 ml ethanol, 1.25 ml distilled water and 0.13 ml of 0.03M HCl was prepared in a 100 ml two neck round bottom flask into which 16.4 ml of tetraethylorthosilicate (TEOS) was added dropwise (TEOS should be handled under dry conditions in a glove bag). The solution was then refluxed at 60° C. for one hour followed by cooling to room temperature. A 10 ml aliquot of this solution was added to a second solution containing 25.5 ml ethanol, 1.75 ml distilled water, 0.1 ml of 1.0 M HCl and 1.3 g of cetyltrimethylammonium bromide. The final mixture was stirred briefly (about 1 min) and then the reaction vessel was sealed with parafilm and set aside to age for one week.

A double polished, 4 inch silicon wafer (4 mm in thickness) was cleaned three times with ethanol, dried with N₂ gas after each wash and then dried in an oven at 100° C. for 30 min. The freshly cleaned 4 inch silicon wafer was then mounted in a spin coater (Laurell, Model WS-400B-6NPP/LITE/8K) and 1.0 ml of the aged solution was carefully added onto the center of the spinning wafer. Then wafer was spun at 1500 rpm. for 45 seconds followed by drying in an oven at 100° C. for 1 hr. Using the same spin coating method, the other side of the wafer was coated with a layer of the mesoporous silica. The wafer was then calcined at a temperature ramp of 1° C./min to 500° C., held at this temperature for 4 hours followed by cooling at 1° C./min to room temperature. Each side of the wafer was recoated two additional times using the above procedure. The wafer was then diced (Diamond Touch Technologies Inc, RFK Series) into chips of 1×1 cm² in size. The surface area of the mesoporous film as estimated by infrared spectroscopy was about 1000 m²/g. The total mass of silica per chip was about 200 μg as measured by the intensity of the combination mode at 1870 cm⁻¹ in the infrared spectrum.

Covalent Attachment of 3-Aminorhodanine (ARH), 1-Benzoyl-3-Thiosemicarbazide (BTSC) and 4,4-Dimethyl-3-Thiosemicarbazide (DTSC) to the Silica Coated Wafer: A silicon chip coated with mesoporous silica was immersed into a 25 ml beaker containing a stirred solution of 10.0 ml of toluene and 1.0 ml of TEA for 30 min. The chip was removed from the beaker and then added immediately to a second stirred solution containing 10.0 ml of toluene and 1.0 ml of TESA for 15 min. After the reaction, the chip was removed from the solution, rinsed with toluene, dried with N₂ gas, and then cured in the oven at 120° C. for 2 hrs. The curing step promotes crosslinking of the silane to the silica surface. The chip was then exposed to air overnight in an open vial. The latter step led to the conversion of the anhydride groups of the attached silane to the corresponding carboxylic acid. Next, the silicon chip was added to 20.0 ml of a stirred solution containing 200 mg of catalyst, EDC in 50% v/v ethanol/distilled water for 30 min. Then 200 mg of ARH, or BTSC, or DTSC was added to the solution and reaction continued in a stirred beaker for 12 hrs under N₂ gas. The chip was removed from the reaction vessel, washed with 50% v/v ethanol/distilled water, dried with N₂ gas and stored in a closed glass vial. Chips containing the attached thiosemicarbazides are collectively denoted as X-[silica] and individually as ARH-[silica], BTSC-[silica], and DTSC-[silica].

Reaction of X-[Silica] with 50 μM Solutions Containing Metal Ions: The X-[silica] chips were separately contacted with excess amounts of 50 μM solutions of Hg(OOCCH₃)₂ in 5% vol. glacial acetic acid/water solution (pH 2.0-2.5), HgCl₂ in 1% conc. HCl/water as well as 50 μM solutions of CdCl₂, PbCl₂, ZnSO₄ and NaOOCCH₃ in 5% acetic acid/water. Reactions of Hg(II) solutions with each X-[silica] material were carried out at different temperatures.

ARH-[silica] chips were immersed in 10 ml beakers containing 5.0 ml of the metal ion solutions and then heated in a standard microwave oven for 90 sec. BTSC-[silica] chips were immersed in 20.0 ml of metal ion solutions in 50 ml beakers and the solutions were heated using a hotplate to various temperatures up to 100° C. for 15 min. DTSC-[silica] chips were immersed in 20.0 ml of metal ion solutions in 50 ml beakers for 15 min at room temperature. The X-[silica] chip was then removed from the beaker, rinsed with 50% v/v ethanol/distilled water, dried with N₂ gas and IR spectra were recorded.

Reaction of DTSC-[Silica] with Varying Amounts of Hg(II): DTSC-[silica] was found to be the best candidate for Hg(II) detection (see Results and Discussion) and thus additional experiments were performed with this material to determine the detection limit. The detection limit is based on the total mass of Hg(II) in contact with the chip and this was, altered by changing both concentration and volume. Furthermore, the reaction time is dictated by mass transport of Hg(II) to the chip surface. IR spectra were recorded every 15 min to monitor the extent of reaction. Prior to recording each IR spectrum, the chips were withdrawn from the beaker, rinsed with 50% v/v ethanol/distilled water, and dried with N₂ gas. Reaction was deemed to be complete when no change in the IR spectra was observed between consecutive measurements. For example, for immersion of the chips in stirred solutions containing 20 ml of 50 μM Hg(II), reaction was completed after about 16 hrs of contact time. For concentrations ranging from 0.05M to 25 μM Hg(II), the chip was placed in a 20 ml of a Hg(II) solution, then withdrawn from the beaker, rinsed with 50% v/v ethanol/distilled water, dried with N₂ gas and IR spectra were recorded.

For detection at lower concentration (or more appropriately, lower total Hg(II) mass) the following procedure was employed. First, the DTSC-[silica] chips were placed in a 10 ml capped vials. Then 20 μl of a higher concentration Hg(II) solutions (0.05 M to 0.0005M) were placed directly onto the chips. The vials were capped and left to stand for 24 hrs during which time the solution evaporates after about 24 hrs and then IR spectra were recorded. The total mass of Hg(II) that is in contact with DTSC-[silica] chips in this 20 μl drop is equivalent to the mass of the 20 ml volume of lower concentration (<25 μM) Hg(II) solutions.

DFT Calculations of DTSC-[Silica] Model Structures: Assignment of infrared bands were performed using Gaussian 03. Model structures were constructed in Gaueview03 and minimized using Gaussian03. Energy minimization and frequency calculations were completed in the B3LYP level of theory using the 6-31 G(d) basis set.

Results and Discussion

Reaction of Model Compounds with Hg(II): The three compounds, ARH-butylmalonic amide (Scheme 4), 1-benzoyl-5,5-dimethyl-3-thiosemicarbazide (Scheme 4), and 1-benzoyl-3-thiosemicarbazide (BTSC, Scheme 3) were mixed with Hg(OOCCH₃)₂ solution separately and the progress of the reaction was determined by the appearance of a black precipitate (HgS). A black precipitate was first observed at reaction temperatures of 40-45° C. for 1-benzoyl-5,5-dimethyl-3-thiosemicarbazide whereas a black precipitate was first observed at 95-100° C. for 1-benzoyl-3-thiosemicarbazide. Solutions containing ARH-butylmalonic amide and Hg(OOCCH₃)₂ only produced a black precipitate only upon heating in a microwave oven. Similar temperatures were required to observe changes in the IR spectra during the reaction of Hg(II) solutions with the corresponding X-[silica] chips. These initial results obtained with the model compounds showed that according to our criteria of a fast reaction at ambient temperatures, DTSC would be the best candidate molecule to anchor to a SPE material for use in an IR based detection method for Hg(II).

Formation of X-[Silica]: An outline of the reaction steps taken to attach each precursor to a mesoporous silica film is shown in Scheme 1. Each step of the process was monitored by IR spectroscopy. In the first step, TEA was used as a catalyst to promote reaction of the linker silane, TESA with the surface hydroxyl groups on the mesoporous silica film. Evidence supporting this reaction is provided by the spectra shown in FIG. 1.a. The two bands that appear at 1860 and 1780 cm⁻¹ are C═O stretching modes of the anhydride functional group. The third band that appears at 1730 cm¹ with a shoulder at 1710 cm¹ are the C═O stretching modes of the carboxylic acids produced by the hydrolysis of the anhydride by residual water vapor in the air.

The disappearance of the band at 3747 cm⁻¹ due to OH stretching mode of SiOH groups (see FIG. 1 inset) indicates that the reaction occurs between the silane linker and the surface hydroxyl groups. It is noted that the reaction sequence depicted in Scheme 1 is an oversimplification of the species formed during the reaction of the silane with silica. For example, trialkoxysilanes are also well known to crosslink forming polymerized products on the surface. While the nature of the silane layer remains ill-defined, a reproducible amount of surface anhydride groups were obtained from chip-to-chip.

The chip was then exposed to humid air overnight and the spectrum shown in FIG. 1.b. was then recorded. The anhydride bands at 1860 and 1780 cm⁻¹ shown in FIG. 1.a. disappear and a band at 1710 cm^{-l} with a shoulder at 1730 cm⁻¹ becomes more intense. This shows that the anhydride is completely converted to the dicarboxylic acid by exposure to air. The spectrum shown in FIG. 1.c. was recorded after the attachment of DTSC to the Si chip. Two new bands appear at 1690 and 1540 cm⁻¹ and these are assigned to amide I and II modes. This provides direct evidence for covalent attachment of the DTSC on the surface via an amide linkage.

FIG. 1.c. also has a band at 1730 cm⁻¹ and this is due to the C═O stretching mode of a dicarboxylic acid. Longer reaction times did not lead to any further decrease in the band at 1730 cm¹. This shows that not all the COOH surface groups react with DTSC. A plausible explanation for COOH groups remaining after the reaction with DTSC is that steric hindrance limits the reaction with only one COOH of the diacid (see Scheme 1).

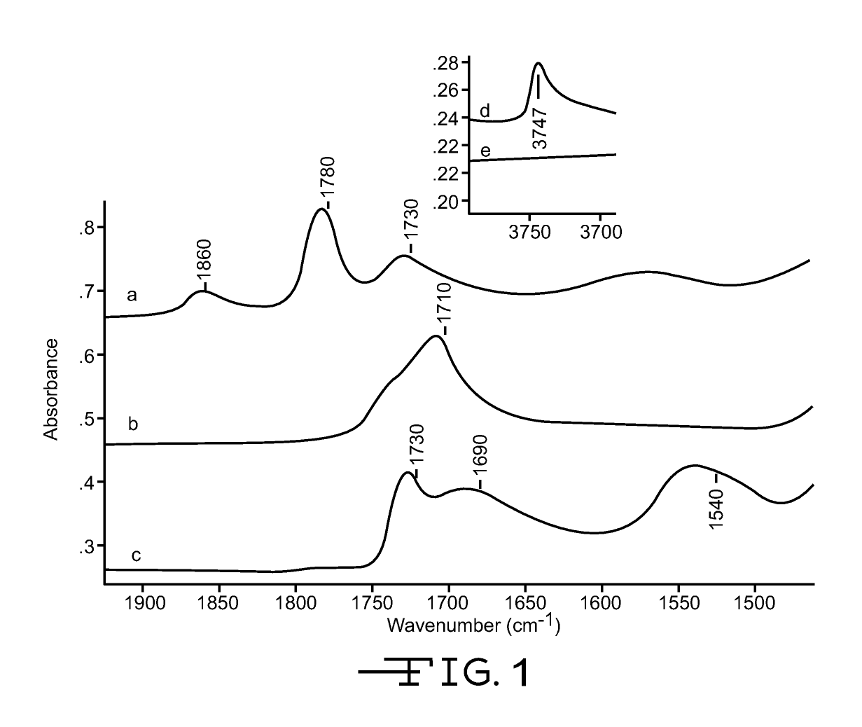

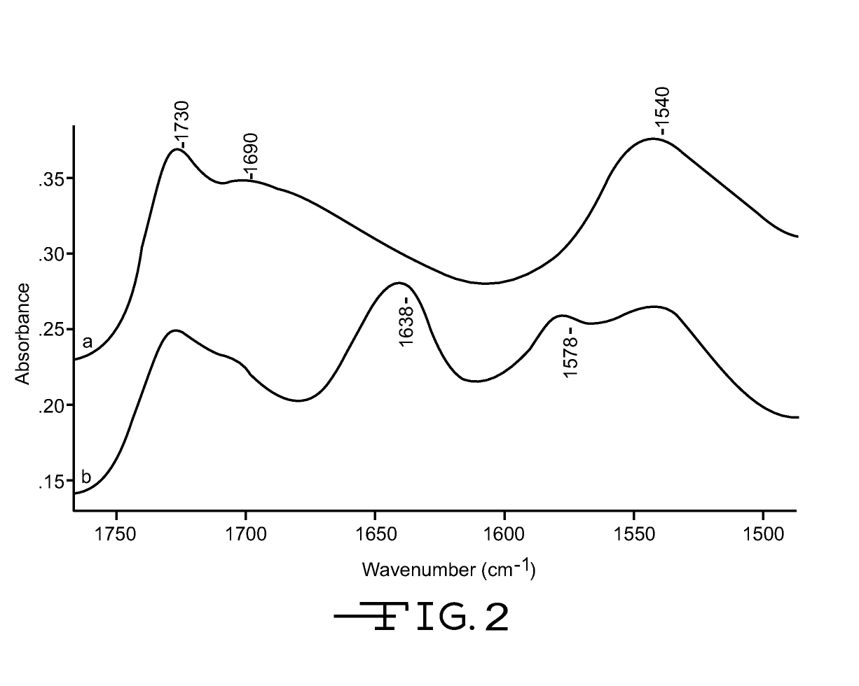

Reaction of DTSC-[Silica] with Aqueous Hg(II) Solutions: The spectrum obtained after immersion of the DTSC-[silica] chip in 20.0 ml of a 50 μM Hg(OOCCH₃)₂ solution is shown in FIG. 2.b. Comparing FIGS. 2.a. and 2.b., contact with Hg(II) solutions result in a decrease in intensity of the two amide bands at 1540 and 1690 cm¹ and this is accompanied by the appearance of two new bands at 1638 and 1578 cm⁻¹. These latter two bands that appear are assigned to the symmetric and asymmetric stretching modes of a C═N bond of the oxadiazole formed in the reaction (see Scheme 2). It is also noted that a black precipitate due to the other byproduct of the reaction, HgS, was observed on the chip surface of the sample used to record the spectrum shown in FIG. 2.b.

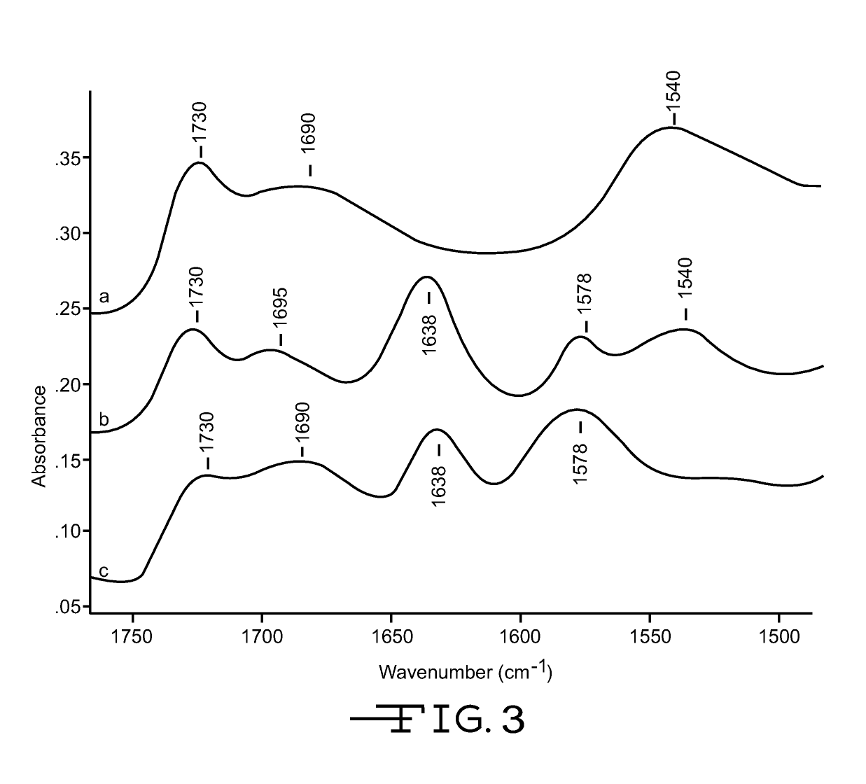

While these spectral changes were observed for samples DTSC-[silica] exposed to solutions containing Hg(OOCCH₃)₂, additional experiments were performed to demonstrate that the above changes are the result of reaction involving Hg(II) ion and not specific to acetate or acetic acid. Specifically, the reactions were performed in solutions of Hg(OOCCH₃)₂ in 5% v/v aqueous acetic acid, HgCl₂ in 1% HCl, NaOOCCH₃ in 5% v/v acetic acid, and 5% v/v acetic acid. The spectra obtained after the reaction of DTSC-[silica] samples with Hg(OOCCH₃)₂, and HgCl₂ are shown in FIGS. 3.b., and 3.c. respectively. A reaction was observed for the samples immersed in Hg(II) ions as shown in Scheme 2. In contrast, the samples immersed in NaOOCCH₃ or acetic acid solutions did not show any changes in the spectrum (not shown). Therefore the conversion of DTSC to oxadiazole is sensitive to Hg(II), not the counter ions Cl₋ or OOCCH₃⁻.

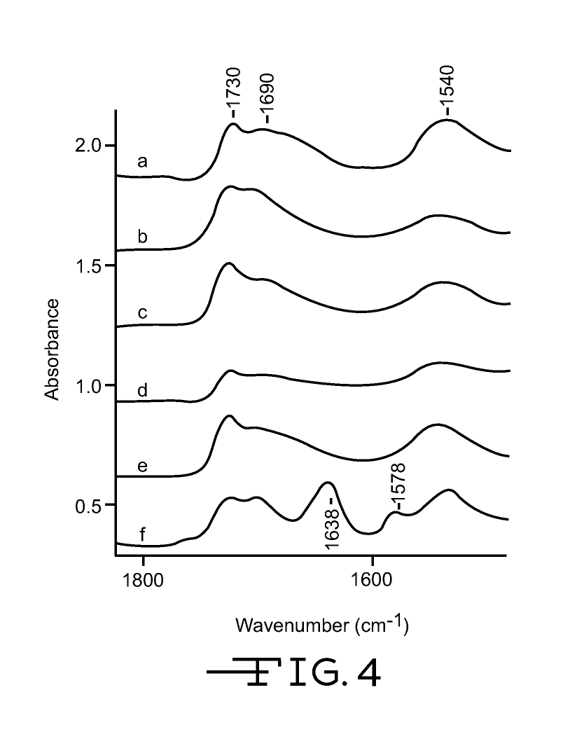

Detection Selectivity: Our next set of experiments were aimed at determining the selectivity of Hg(II) in converting the immobilized thiosemicarbazide to an oxadiazole. Samples of DTSC-[silica] were immersed separately in 20 ml of 50 μM solutions of Pb(NO₃)₂, CdCl₂, FeCl₃, and ZnSO₄, for 16 hours and IR spectra were then recorded for each sample (see FIG. 4).

In FIG. 4, the amide I and II bands at 1638 and 1578 cm⁻¹, which provide evidence of oxadiazole formation, were not observed in the spectra when DTSC-[silica] chips were immersed in 50 μM of Cd(II), Pb(II), Fe(II) or Zn(II) ion solutions. These experiments point to a high degree of selectivity towards Hg(II) detection by the proposed SPE/IR method.

Detection. Limit: Since HgS is produced as a byproduct of the reaction of DTSC-[silica] with Hg(II) (see Scheme 2), the reaction proceeds stoichiometrically and the amount of oxadiazole formed would be determined by the mass of Hg(II) coming in contact with the sample chip. As a result, the detection limit will depend on both the concentration of Hg(II) and the volume in contact with the DTSC-[silica] sample. To measure the detection limit, we used the amount of oxadiazole formed during the reaction as determined from the integrated intensity of the peak at 1638 cm⁻¹.

The integrated area of the 1638 cm^{-l} peak was calculated using the curve fitting program in Grams AI software using the following procedure. The IR spectrum of DTSC-[silica] before the reaction with Hg(II) was subtracted from the IR spectrum of DTSC-[silica] after the reaction with Hg(II) solution. The difference spectrum produced contains both positive and negative bands. Five bands centered at 1730, 1690, 1638, 1578, and 1540 cm⁻¹ were then fitted using the curve fitting program.

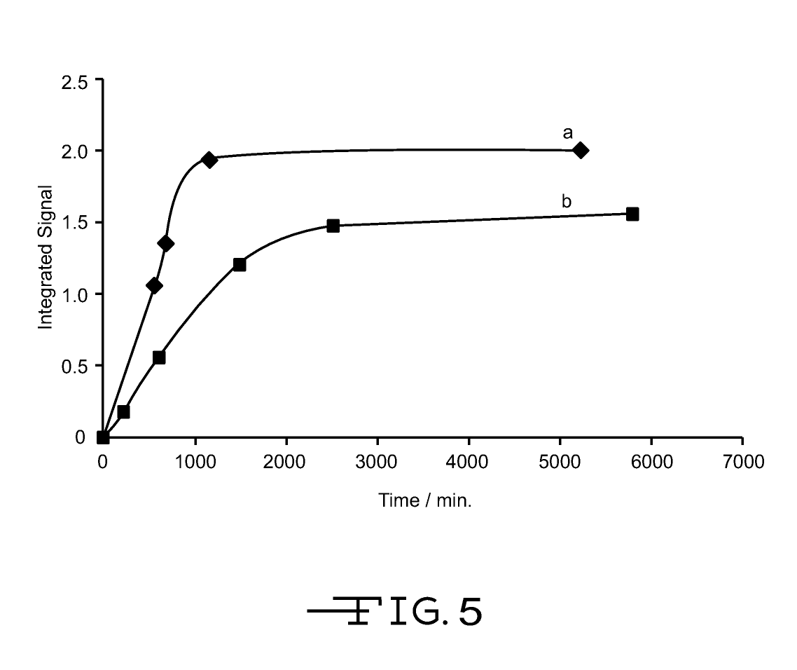

FIG. 5 shows the integrated area of the band at 1638 cm⁻¹ as a function of contact time. The reaction was deemed to be complete when there is no change in two consecutive IR spectra. For contact with 20 ml of 50 μM and 20 ml of 25 μM Hg(II), reaction was complete in about 16 and 41 hours respectively, consistent with a mass transport limited reaction.

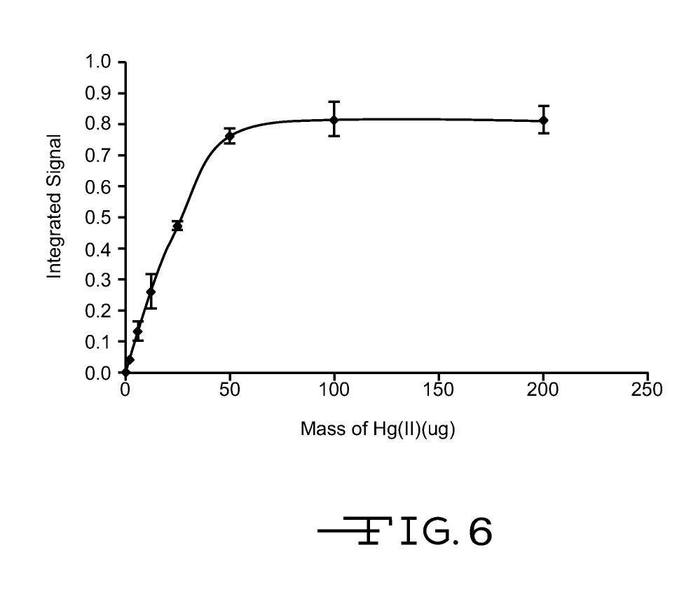

The time required to achieve complete reaction was taken into account when generating a calibration curve. The samples were immersed in solutions of varying concentrations and volumes of Hg(II) and the values obtained in the plateau regions of the time dependent curves were then used to generate the calibration curve shown in FIG. 6. All experiments were carried out a minimum of three times and the error bars indicate the 95% confidence level.

The curve in FIG. 6 shows that the reaction proceeds stoichiometrically as predicted by the reaction in Scheme 2 and plateaus in value at about 50 μg Hg(II). A plateau would occur when the total Hg(II) is in excess of the amount of DTSC anchored to the chip and we estimate that this would occur at about 50 μg Hg(II). The estimate was determined as follows. From the IR spectrum the surface area of the mesoporous silica is about 1000 m²/g. The amount of silica per chip is 200 μg resulting in a total surface area of the mesoporous silica of about 0.200 m² per chip. The number of isolated hydroxyl groups on silica is around 1.5 OH/nm². Assuming one DTSC per attached silane (i.e. one isolated OH), the number of DTSC per chip is estimated to be about 2.54×10⁻⁷ mols. Since the reaction of DTSC with Hg(II) is 1:1, the total mass of Hg(II) required to react with all available DTSC-[silica] per chip is around 50.8 μg which is the same as experimental value of 50 μg (see FIG. 6).

The method of detection limit (MDL) was determined following EPA guidelines. Seven replicates with the mass of Hg(II) three times higher than the mass of the theoretical detection limit (2 μg) were used. Using three standard deviations to determine the MDL, the detection limit is approximately 5.4 μg Hg(II) per chip. For a 5 μg Hg(II) sample in 1 liter, this translates to detection limit around 5 ppb.

In principle, the detection limit could be lowered by throughput matching the active area of the coating to the infrared beam. The integrated intensity of 1638 cm⁻¹ peak will follow the well known concentration-path length dependence as determined by Beer's Law and thus is proportional to the amount of oxadiazole formed per area of the infrared beam. In our experiments, the Si chips are 1×1 cm² whereas the infrared beam diameter at the sample focus is about 6.5 mm. Thus the coatings on the Si chips are not throughput matched to the infrared beam in that about 66% of the Hg(II) has reacted with the anchored thiosemicarbazide outside of the area irradiated by the infrared light. The concept of throughput matching to lower the spectroscopic detection limit could be extended to smaller sample beam area. For example, by reducing the active area of the coating to 1 mm² and throughput matching the diameter of the infrared beam using beam condensers to this area would lead to an additional factor of 40 improvement in the spectroscopic detection limit. However, with the current chip, achieving this detection limit would be difficult due to mass transport limitations. We are investigating approaches to circumvent this limitation using thiosemicarbazide tethered to porous membranes.

### CONCLUSION

This work has demonstrated that covalent immobilization of 4,4-dimethyl-3-thiosemicarbazide to mesoporous silica films can be used to selectively detect Hg(II) in aqueous solutions using FT-IR. Hg(II) stoichiometrically react with thiosemicarbazide to produce stable HgS and as a result thiosemicarbazide forms a cyclic oxadizole. The surface bound 4,4-dimethyl-3-thiosemicarbazide has a higher degree of selectivity towards Hg(II) over other competing ions such as Pb(II), Cd(II), Fe(III), and Zn(II). Moreover, the reaction occurs at room temperature making the thiosemicarbazide attached silica chips more robust. These findings here provide a critical step towards developing robust Hg(II) sensors.

The principle and mode of operation of the detection method and detection system have been explained and illustrated in their preferred embodiments. However, it must be understood that they may be practiced otherwise than as specifically explained and illustrated without departing from their spirit or scope.

What is claimed is:

1. A method for detecting and measuring a metal ion in an aqueous medium comprising:
derivatizing a solid phase extraction material with a reactive material that undergoes a chemical reaction when contacted with the metal ion;
positioning the solid phase extraction material and the reactive material in an aqueous medium containing the metal ion, such that the metal ion contacts the reactive material and causes it to chemically react; and
detecting the reaction of the reactive material by optical spectroscopy to detect and measure the metal ion.

2. The method of claim 1 wherein the metal ion is a mercury, gold, zinc or silver ion.

3. The method of claim 1 wherein the reactive material is a thiosemicarbazide, acylthiosemicarbazide, propargylic carboxamide, propargylic alcohol, alkyne, alkene, allenic ketone, thioallene, hydroxyallene, or allenic ester.

4. The method of claim 1 wherein the metal reacts as a thiophile with the molecule tethered to the surface.

5. The method of claim 1 wherein the metal is involved in a nucleophilic reaction of oxygen, nitrogen or sulfur with an unsaturated carbon-carbon bond in a molecule tethered to the surface.

6. The method of claim 1 wherein the chemical reaction is stoichiometric.

7. The method of claim 1 wherein the chemical reaction is catalytic.

8. The method of claim 1 wherein the optical spectroscopy is infrared spectroscopy.

9. A detection system for detecting and measuring a metal ion in an aqueous medium comprising:
a solid phase extraction material derivatized with a reactive material that undergoes a chemical reaction when contacted with the metal ion; and
an optical spectrometer adapted to detect the changing of the optical spectrum of the reactive material caused by the chemical reaction thereby allowing the spectrometer to detect and measure the metal ion.

10. The detection system of claim 9 wherein the metal ion is a mercury, gold, zinc or silver ion.

11. The detection system of claim 9 wherein the reactive material is a thiosemicarbazide, acylthiosemicarbazide, propargylic carboxamide, propargylic alcohol, alkene, alkene, allenic ketone, thioallene, hydroxyallene, or allenic ester.

12. The detection system of claim 9 wherein the metal reacts as a thiophile with the molecule tethered to the surface.

13. The detection system of claim 9 wherein the metal is involved in a nucleophilic reaction of oxygen, nitrogen or sulfur with an unsaturated carbon-carbon bond in a molecule tethered to the surface.

14. The detection system of claim 9 wherein the chemical reaction is stoichiometric.

15. The detection system of claim 9 wherein the chemical reaction is catalytic.

16. The detection system of claim 9 wherein the optical spectrometer is an infrared spectrometer.
